(19) United States
(12) Patent Application Publication
(10) Pub. No.: US 2012/0204834 A1
(43) Pub. Date: Aug. 16, 2012

(54) Injection System for an Internal Combustion Engine

(76) Inventor: Stephan Jonas, Mintraching (DE)

(21) Appl. No.: 13/124,636

(22) PCT Filed: Oct. 15, 2009
(86) PCT No.: PCT/EP2009/063496

§ 371 Date: May 27, 2011

(30) Foreign Application Priority Data
Oct. 16, 2008 (DE) 102008051931.6

(51) Int. Cl. F02M 63/00

(52) U.S. Cl. 123/447

(57) ABSTRACT

An injection system for an internal combustion engine (50) has an injector (22) that is hydraulically coupled to a field reservoir (16), a pump element (14) of a pump-nozzle arrangement or a pump-line-nozzle arrangement. The pump element (14) can be adapted to feed fuel from a fuel tank (10) to the fuel reservoir (16), and the pump element (14) is mechanically coupled to a crankshaft (18) of the internal combustion engine (50) in such a way that the pump element (14) can be driven by the crankshaft (18).

### CROSS-REFERENCE TO RELATED APPLICATIONS

This application is a U.S. National Stage Application of International Application No. PCT/EP2009/063496 filed Oct. 15, 2009, which designates the United States of America, and claims priority to German Application No. 10 2008 051 931.6 filed Oct. 16, 2008, the contents of which are hereby incorporated by reference in their entirety.

### TECHNICAL FIELD

The invention relates to an injection system for an internal combustion engine.

### BACKGROUND

In order to inject fuels into combustion chambers of an internal combustion engine, in particular a diesel internal combustion engine, injection systems are used which in the last years have been designed increasingly as what are known as “common rail” systems. In the latter, the injectors which are arranged in the combustion chambers are supplied with fuel from a common fuel accumulator, the common rail. Here, the fuel to be injected is present in the fuel accumulator at a pressure of up to over 2000 bar.

Injection systems for internal combustion engines usually have various pumps, by means of which fuel is conveyed, in order to be introduced into combustion chambers of the internal combustion engine. Injection systems of this type for internal combustion engines make high requirements of the accuracy of the injection pressure which is required for injecting the fuel into the combustion chambers of the internal combustion engine.

This is particularly important, since more and more stringent legal directives are released with regard to the permissible pollutant emissions of internal combustion engines which are arranged in motor vehicles. Said directives make it necessary to take diverse measures, by way of which the pollutant emissions are lowered. Thus, for example, the formation of soot is greatly dependent on the preparation of the air/fuel mixture in the respective cylinder of the internal combustion engine. Here, it is advantageous for the lowering of the pollutant emissions if the fuel can be injected very precisely into the cylinder.

DE 101 32 732 A1 has disclosed a fuel injection system for an internal combustion engine, which fuel injection system has, as a function of the number of cylinders, at least one local pump element, which is assigned to each injector, of a pump/nozzle unit or of a pump/line/nozzle system for compressing the fuel. Injectors are connected to a central fuel pressure accumulator.

### SUMMARY

According to various embodiments, an injection system for an internal combustion engine can be provided, by way of which operation of the internal combustion engine with very low pollutant emissions and a simple design of the injection system are made possible.

according to an embodiment, an injection system for an internal combustion engine may have at least one injector which is coupled hydraulically to a fuel accumulator, a pump element of a pump/nozzle arrangement or of a pump/line/nozzle arrangement,

the pump element being configured for conveying fuel out of a fuel tank into the fuel accumulator, and the pump element being coupled mechanically to a crankshaft of the internal combustion engine, in such a way that the pump element can be driven by the crankshaft.

According to a further embodiment, the system may have a further pump element of a pump/nozzle arrangement or a pump/line/nozzle arrangement, which further pump element is configured for conveying fuel out of the fuel tank into the fuel accumulator and is coupled mechanically to the crankshaft of the internal combustion engine, in such a way that the further pump element can be driven by the crankshaft, the further pump element being arranged so as to lie opposite the pump element in relation to a rotational axis of the crankshaft. According to a further embodiment, at least one of the pump elements can be coupled directly to the crankshaft. According to a further embodiment, the system may have a volumetric flow regulating valve which is arranged upstream of the pump element and/or of the further pump element and by way of which the fuel flow into the pump element and/or the further pump element can be set, the volumetric flow regulating valve having an actuating means which is synchronized hydraulically to the pump element and/or the further pump element.

### BRIEF DESCRIPTION OF THE DRAWINGS

In the following text, an embodiment is explained in greater detail using the diagrammatic drawing, in which:

FIG. 1 shows a block circuit diagram of an injection system for an internal combustion engine, and

FIG. 2 shows a diagrammatic view of an internal combustion engine.

Elements of identical construction or functions are labeled across the figures with the same designations.

### DETAILED DESCRIPTION

Various embodiments are distinguished by an injection system for an internal combustion engine, having at least one injector which is coupled hydraulically to a fuel accumulator, a pump element of a pump/nozzle arrangement or of a pump/line/nozzle arrangement, the pump element being configured for conveying fuel out of a fuel tank into the fuel accumulator, and the pump element being coupled mechanically to a crankshaft of the internal combustion engine, in such a way that the pump element can be driven by the crankshaft.

This is particularly advantageous, since it is therefore possible to dispense with a pump housing and a drive apparatus for a high pressure pump. Rather, the previously utilized pump element can be used in the injection system for the generation of a high fuel pressure. A homogeneously high pressure of the fuel can be achieved in a simple way. Moreover, no structural reinforcement of the camshaft is required as in the case of the pump/nozzle arrangement or the pump/line/nozzle arrangement. Furthermore, a compact design and therefore a high degree of energy efficiency of the pump element are possible. Overall, this results in a low weight and a low material requirement. Accordingly, the costs can also be low.

According to an embodiment, the injection system has a further pump element of a pump/nozzle arrangement or of a pump/line/nozzle arrangement, which further pump element is configured for conveying fuel out of the fuel tank into the fuel accumulator and is coupled mechanically to the crankshaft of the internal combustion engine. The coupling is configured in such a way that the further pump element can be driven by the crankshaft. The further pump element is arranged so as to lie opposite the pump element in relation to a rotational axis of the crankshaft. This is particularly advantageous, since it is thus possible that the torque is low. In turn, a high fuel delivery volume can be achieved with an unchanged high torque.

In a further embodiment, at least one of the pump elements is coupled directly to the crankshaft. Only a small amount of installation space is therefore required for coupling the pump elements to the crankshaft.

In a further embodiment, the injection system has a volumetric flow regulating valve which is arranged upstream of the pump element and/or of the further pump element and by way of which the fuel flow into the pump element and/or the further pump element can be set. The volumetric flow regulating valve has an actuating means which is synchronized hydraulically to the pump element and/or the further pump element. No inlet valve is therefore required on the pump element, and satisfactory controllability of the fuel flow into the pump elements is possible.

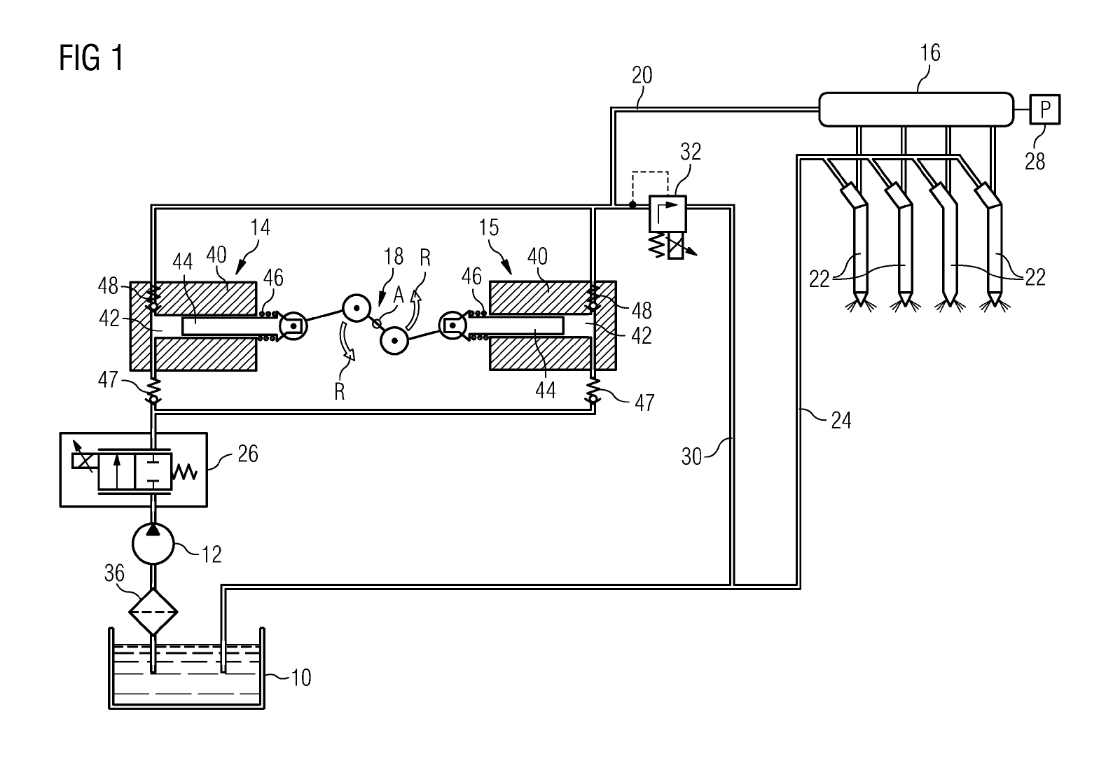

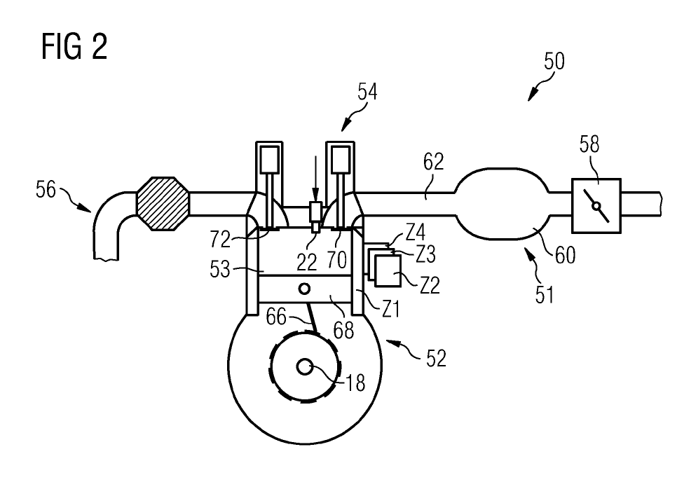

The injection system shown in FIG. 1 for an internal combustion engine 50 has a fuel tank 10, out of which fuel is conveyed by means of a prefeed pump 12. The prefeed pump 12 is preferably configured as a vane cell pump. However, another pump type can also be used for the prefeed, for example a gearwheel pump or a gerotor pump. The prefeed pump 12 can be driven mechanically by way of a drive shaft (not shown) which is coupled to an engine shaft of the internal combustion engine 50 (FIG. 2). As an alternative, however, it is also possible to use an electrically operated prefeed pump 12, as a result of which it is possible to control the delivery rate of the prefeed pump 12 independently of the delivery rate of further pumps. The prefeed pump 12 can also be dispensed with in further embodiments. The fuel pressure at the outlet side of the prefeed pump 12 can be limited by a pilot pressure control valve (not shown).

Pump elements 14, 15 for conveying the fuel into a fuel accumulator 16 are arranged downstream of the prefeed pump 12. Only one of the pump elements 14, 15 can also be arranged downstream of the prefeed pump 12 in further embodiments. The pump elements 14, 15 are parts of a pump/nozzle arrangement or of a pump/line/nozzle arrangement.

The pump elements 14, 15 are of substantially identical design. The pump elements 14, 15 substantially comprise a housing 40, a pump chamber 42 which is arranged in the housing 40, a high pressure piston 44 and a spring 46. The housing 40 is preferably a constituent part of an engine block 52 of the internal combustion engine 50 (FIG. 2). The high pressure piston 44 is mounted axially movably in the pump chamber 42 of the housing 40 and is operatively connected to a crankshaft 18. The spring 46 is preferably supported on the housing 40 and on the high pressure piston 44.

In order for it to be possible for the pump chamber 42 to be filled with fuel, said pump chamber 42 has an inflow line and an inlet valve 47 which is arranged in said inflow line, via which fuel can flow into the pump chamber 42. Furthermore, the pump chamber 42 has an outflow line and an outlet valve 48 which is arranged in said outflow line, via which fuel can be ejected out of the pump chamber 42 in the direction of the fuel accumulator 16.

The pump elements 14, 15 are directly connected mechanically to the crankshaft 18 of the internal combustion engine, with the result that they can be driven by the crankshaft 18 and the space requirement for the coupling is very small. In further embodiments, a transmission lever can also be arranged between the pump elements 14, 15 and the crankshaft 18, by way of which transmission lever forces can be transmitted satisfactorily between the pump elements 14, 15 and the crankshaft 18. The further pump element 15 is arranged so as to lie opposite the pump element 14, that is to say offset by 180°, in relation to a rotational axis A of the crankshaft 18.

The fuel accumulator 16 is coupled hydraulically to the pump elements 14, 15 via a fuel accumulator feed line 20.

Furthermore, the fuel accumulator 16 is coupled hydraulically via lines to an injector 22 or a plurality of injectors 22. Each of the injectors 22 is assigned a combustion chamber 53 (FIG. 2) of the internal combustion engine 50, and each injector 22 can be actuated in such a way that fuel is injected into the combustion chamber 53 of the internal combustion engine 50. As a result of the pump elements 14, 15, the fuel which is to be injected by means of the injectors 22 into the combustion chambers 53 of the internal combustion engine 50 can reach a relatively high injection pressure.

Excess fuel can be returned to the fuel tank 10 from the injectors 22 via an injector return line 24.

A volumetric flow regulating valve 26, by way of which the fuel flow from the prefeed pump 12 into the pump elements 14, 15 can be set, is arranged between the prefeed pump 12 and the pump elements 14, 15. By means of a pressure sensor 28, by way of which the fuel pressure in the fuel accumulator 16 can be determined, and optionally as a function of further input variables, the volumetric flow regulating valve 26 can be actuated in such a way that low pressure-side regulation of the fuel flow which is fed to the pump elements 14, 15 is possible.

In a further embodiment of the injection system, in each case one of the volumetric flow regulating valves 26 which is actuated in each case in a hydraulically synchronized manner with the pump element 14, 15 assigned to it is arranged between the prefeed pump 12 and the pump elements 14, 15. In this configuration, the inlet valves 47 can be omitted.

The pump elements 14, 15 are coupled hydraulically to a pressure regulating valve 32 by means of a return line 30 which branches off downstream of the pump elements 14, 15 and upstream of the fuel accumulator 16. The pressure regulating valve 32 can be actuated, for example, as a function of the fuel pressure determined by the pressure sensor 28 in the fuel accumulator 16. If a predefined fuel pressure is exceeded in the fuel accumulator 16, the pressure regulating valve 32 can open and a part of the fuel which is conveyed from the pump elements 14, 15 can be returned via the return line 30 into the fuel tank 10.

A filter 36 is provided between the fuel tank 10 and the prefeed pump 12 in order to protect the assemblies which are arranged in the injection system, in particular the pump 12, the pump elements 14, 15 and the control valves 22, 20.

The pressure regulating valve 32 is arranged in the return line 30 which is coupled on the outlet side to the injector return line 24 of the at least one injector 22. The return line 30 and the injector return line 24 from the injectors 22 are preferably routed back to the fuel tank 10.

FIG. 2 shows the internal combustion engine 50, having an intake section 51, the engine block 52, a cylinder head 54 and an exhaust gas section 56. The intake section 51 preferably comprises a throttle valve 58, a manifold 60 and an intake manifold 62. The intake manifold 62 is routed toward a cylinder Z1 via an inlet channel into the combustion chamber 53 of the engine block 52. Furthermore, the engine block 52 comprises the crankshaft 18 which is coupled to a piston 68 of the cylinder Z1 via a connecting rod 66.

The cylinder head 54 comprises a gas inlet valve 70, a gas outlet valve 72 and the injector 22.

In addition to the cylinder Z1, further cylinders Z2 to Z4 are preferably also provided.

In the following text, the function of the injection system for the internal combustion engine 50 is to be described:

The prefeed pump 12 conveys fuel out of the fuel tank 10, it being possible for contaminants to be retained in the filter 36 between the fuel tank 10 and the prefeed pump 12. The fuel then passes to the volumetric flow regulating valve 26. The volumetric flow regulating valve 26 provides as much fuel to the pump elements 14, 15 as is required by the fuel accumulator 16.

If the volumetric flow regulating valve 26 has an actuating means which is synchronized hydraulically to the pump elements 14, 15, no inlet valves 47 have to be arranged in front of or in the pump elements 14, 15, and nevertheless satisfactory regulation of the fuel flow into the pump elements 14, 15 is possible.

As a result of a rotational movement of the crankshaft 18 in a rotational direction R, the high pressure pistons 44 in the pump chambers 42 are moved toward the rotational axis A in such a way that said pump chambers 42 are filled with fuel via the inflow line and the open inlet valves 47.

As a result of the further rotational movement of the crankshaft 18 in the rotational direction R, the high pressure pistons 44 are moved away from the rotational axis A in such a way that the fuel which is situated in the pump chambers 42 is compressed. The compressed fuel is ejected out of the pump elements 14, 15 via the outflow line and the open outlet valves 48, and is delivered to the fuel accumulator 16 via the fuel accumulator feed line 20. The fuel is fed from the fuel accumulator 16 to the injectors 22, and is injected by the latter into the combustion chambers 53 of the internal combustion engine 50.

The fuel pressure which is required for the fuel accumulator is fixed by the pressure regulating valve 32. If the pressure in the fuel accumulator feed line 20 and therefore in the fuel accumulator 16 rises too much or if the pressure in the fuel accumulator 16 is to be reduced in a targeted manner, fuel can be discharged into the fuel tank 10 by means of the pressure regulating valve 32. Furthermore, fuel is guided back out of the return line 24 from the injectors 22 into the fuel tank 10.

### List of Designations

10 Fuel tank

12 Prefeed pump

14 Pump element

15 Further pump element

16 Fuel accumulator

18 Crankshaft

20 Fuel accumulator feed line

22 Injector

24 Injector return line

26 Volumetric flow regulating valve

28 Pressure sensor

30 Return line

32 Pressure regulating valve

36 Filter

40 Housing

42 Pump chamber

44 High pressure piston

46 Spring

47 Inlet valve

48 Outlet valve

50 Internal combustion engine

51 Intake section

52 Engine block

53 Combustion chamber

54 Cylinder head

56 Exhaust gas section

58 Throttle valve

60 Manifold

62 Intake manifold

66 Connecting rod

68 Piston

70 Gas inlet valve

72 Gas outlet valve

A Rotational axis

R Rotational direction

What is claimed is:

1. An injection system for an internal combustion engine, comprising
at least one injector which is coupled hydraulically to a fuel accumulator,
a pump element of a pump-nozzle arrangement or of a pump-nozzle arrangement,
the pump element being configured for conveying fuel out of a fuel tank into the fuel accumulator, and
the pump element being coupled mechanically to a crankshaft of the internal combustion engine, in such a way that the pump element can be driven by the crankshaft.

2. The injection system according to claim 1, comprising a further pump element of the pump-nozzle arrangement or the pump-nozzle arrangement, which further pump element is configured for conveying fuel out of the fuel tank into the fuel accumulator and is coupled mechanically to the crankshaft of the internal combustion engine, in such a way that the further pump element can be driven by the crankshaft, the further pump element being arranged so as to lie opposite the pump element in relation to a rotational axis of the crankshaft.

3. The injection system according to claim 1, wherein the pump element is coupled directly to the crankshaft.

4. The injection system according to claim 2, comprising a volumetric flow regulating valve which is arranged upstream of at least one of the pump element and of the further pump element and by way of which the fuel flow into at least one of the pump element and the further pump element can be set, the volumetric flow regulating valve having an actuating means which is synchronized hydraulically to at least one of the pump element and the further pump element.

5. The injection system according to claim 2, at least one of the pump elements being coupled directly to the crankshaft.

6. The injection system according to claim 1, comprising a volumetric flow regulating valve which is arranged upstream of the pump element and by way of which the fuel flow into the pump element can be set, the volumetric flow regulating valve having an actuating means which is synchronized hydraulically to the pump element.

7. An injection system for an internal combustion engine, comprising
at least one injector which is coupled hydraulically to a fuel accumulator,
a pump element being configured for conveying fuel out of a fuel tank into the fuel accumulator, and
the pump element being mechanically driven by a crankshaft of the internal combustion engine.

8. The injection system according to claim 7, comprising a further pump element configured for conveying fuel out of the fuel tank into the fuel accumulator and mechanically driven by the crankshaft of the internal combustion engine, wherein the further pump element is arranged so as to lie opposite the pump element in relation to a rotational axis of the crankshaft.

9. The injection system according to claim 7, wherein the pump element is coupled directly to the crankshaft.

10. The injection system according to claim 8, wherein at least one of the pump elements being coupled directly to the crankshaft.

11. The injection system according to claim 7, comprising a volumetric flow regulating valve which is arranged upstream of the pump element and by way of which the fuel flow into the pump element can be set, the volumetric flow regulating valve having an actuating means which is synchronized hydraulically to the pump element.

12. The injection system according to claim 8, comprising a volumetric flow regulating valve which is arranged upstream of at least one of the pump element and of the further pump element and by way of which the fuel flow into at least one of the pump element and the further pump element can be set, the volumetric flow regulating valve having an actuating means which is synchronized hydraulically to at least one of the pump element and the further pump element.

13. A method for injecting fuel into an internal combustion engine, comprising
coupling at least one injector hydraulically to a fuel accumulator,
driving a pump element mechanically by a crankshaft of the internal combustion engine to convey fuel out of a fuel tank into the fuel accumulator.

14. The method according to claim 13, comprising driving a further pump element mechanically by the crankshaft of the internal combustion engine to convey fuel out of the fuel tank into the fuel accumulator, wherein the further pump element is arranged so as to lie opposite the pump element in relation to a rotational axis of the crankshaft.

15. The method according to claim 13, wherein the pump element is coupled directly to the crankshaft.

16. The method according to claim 14, wherein at least one of the pump elements being coupled directly to the crankshaft.

17. The method according to claim 13, comprising setting the fuel flow into the pump element by a volumetric flow regulating valve which is arranged upstream of the pump element, the volumetric flow regulating valve having an actuating means which is synchronized hydraulically to the pump element.

18. The method according to claim 14, comprising setting the fuel flow into at least one of the pump element and the further pump element by a volumetric flow regulating valve which is arranged upstream of at least one of the pump element and of the further pump element, the volumetric flow regulating valve having an actuating means which is synchronized hydraulically to at least one of the pump element and the further pump element.
